(19) United States
(12) Patent Application Publication
(10) Pub. No.: US 2014/0207392 A1
(43) Pub. Date: Jul. 24, 2014

(54) System to Identify Gas Usage by Appliance

(71) Applicant: ITRON, INC., Liberty Lake, WA (US)

(72) Inventor: Mark K. Cornwall, Spokane, WA (US)

(73) Assignee: ITRON, INC., Liberty Lake, WA (US)

(21) Appl. No.: 13/747,295

(22) Filed: Jan. 22, 2013

(51) Int. Cl. G01F 22/00; G01F 25/00; G06F 17/00

(52) U.S. Cl. CPC G01F 22/00; G06F 17/00; G01F 25/0053
USPC 702/45; 702/88; 702/100

(57) ABSTRACT

A system, including a utility meter, smart meter and/or a central office of a utility company may provide output to assist consumers to identify gas use by individual appliances. The system may measure gas flow rates, categorize the rates to assist in association with a gas consuming appliance, and provide output to identify use by one or more appliances. The output may include information on consumption and/or cost associated with one or more appliances, such as a furnace, hot water tank and/or stove. The output may be graphical, tabular or otherwise presented in any desired user interface or invoice, etc.

### BACKGROUND

Gas meters and gas meter endpoints monitor gas consumption, allowing a utility company to determine quantities of gas consumed over a measurement period at respective endpoint locations. Gas meters may contain components such as gears, shafts, diaphragms and/or switches to measure gas consumption. Often, gas meters have one or more dials or readouts that display a running total of gas consumption.

Gas meters may be augmented or integrated with electronic encoder-receiver-transmitter (ERT®) devices to facilitate radio frequency (RF) based meter data transmission as part of an Automated Meter Reading (AMR) system and to provide data-logging and reporting associated with gas consumption. Such augmented meters accumulate and store gas consumption information over various measurement periods, such as hourly, monthly, etc., and provide accumulated total gas consumption information associated with an endpoint location to a utility for billing and other purposes.

Gas meters are used to monitor gas consumption at residential/commercial endpoint locations that may have a variety of gas consuming appliances. For example, a residential home endpoint location may have gas consuming appliances that include a gas water heater with a pilot light, a gas furnace with an electronic ignition, a gas stove, a gas fireplace, and the like. Because these appliances consume gas, a gas meter will measure the total gas consumed by a combination of all of the appliances.

However, this total gas consumption information does not provide an indication of gas consumption associated with individual gas consuming appliances at an endpoint location.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example of a utility data collection device for associating gas flow rates with gas consuming loads.

FIG. 2 is a schematic diagram of an example of a distributed processing environment and a utility data collection device for associating gas flow rates with gas consuming loads.

FIG. 3 is an example chart showing bins and bin allocations of various consumption rates associated with various gas consuming appliances.

FIG. 4 is a further example chart showing bins and bin allocations of various consumption rates associated with various gas consuming appliances.

FIG. 5 is an example chart showing total accumulated costs associated with various gas consuming appliances.

FIG. 6 illustrates an example method of accumulating consumption data indicating consumption of individual loads.

FIG. 7 illustrates a further example method of accumulating consumption data indicating consumption of consumption loads.

### DETAILED DESCRIPTION

### Overview

As noted above, existing gas meters totalize gas usage over a period of time, such as per hour or per month, and record this usage as an hourly or monthly total consumption amount. However, such meters fail to provide instantaneous consumption information and fail to associate consumption with individual consuming appliances.

This application describes techniques that may be implemented by an enhanced gas meter (e.g., an endpoint), central office or other location to determine and accumulate gas usage information at various consumption rates associated with gas consuming loads (e.g., gas appliances). As an example, an enhanced gas meter measures gas flow rates, categorizes the measured gas flow rates, associates the categorized gas flow rates with gas consuming loads and/or appliances and outputs a result to include gas consumption data with the gas consuming loads. In this example, gas flow rates of individual gas consuming loads and gas flow rates indicating simultaneous operation of multiple individual gas consuming loads may be recognized. Gas consuming appliances (e.g., gas water heater, gas furnace) may be associated with gas consumption such that a consumer may track a total consumption or a total cost of operating individual appliances over a measurement period.

Various gas consuming appliances, such as a furnace or water heater, use an approximately constant rate of gas while they operate. Other gas consuming appliances, such as a stove, may use a variable rate of gas depending on a burner setting or oven temperature selection. Pilot lights have a relatively low but constant rate of gas consumption. By recording an amount of gas used at various consumption rates, information may be extracted that indicates how much gas is used by individual gas appliances.

A usage profile may be collected, such as by a utility company, and made available to a customer via a web site, an in-home display, on a monthly bill, or the like. As an example, a customer or utility company may associate each gas consuming appliance with accumulated gas flow rate data. A customer may then monitor estimated costs associated with individual gas consuming appliances as well as usage changes over time of individual gas consuming appliances. As an example, a customer may discover that a water heater is consuming more gas than was normal in the past, which may be attributable to a calcium build-up in the tank of the water heater. As another example, a consumer may discover that a gas furnace is consuming more gas than was normal in the past, which may indicate that the furnace needs servicing. A chart may be provided to a customer indicating how individual gas appliances contribute to total overall gas consumption.

Multiple and varied implementations and embodiments are described below, beginning with an “Example Environment,” followed by “Example Bin Allocation of Consumption Rates” and “Example Methods of Determining Consumption Rates.” Finally, the application concludes with a brief “Conclusion.” This Overview and the following sections, including the section headings, are merely illustrative implementations and embodiments and should not be used to interpret the claims or to limit the scope of the claims.

### Example Environments

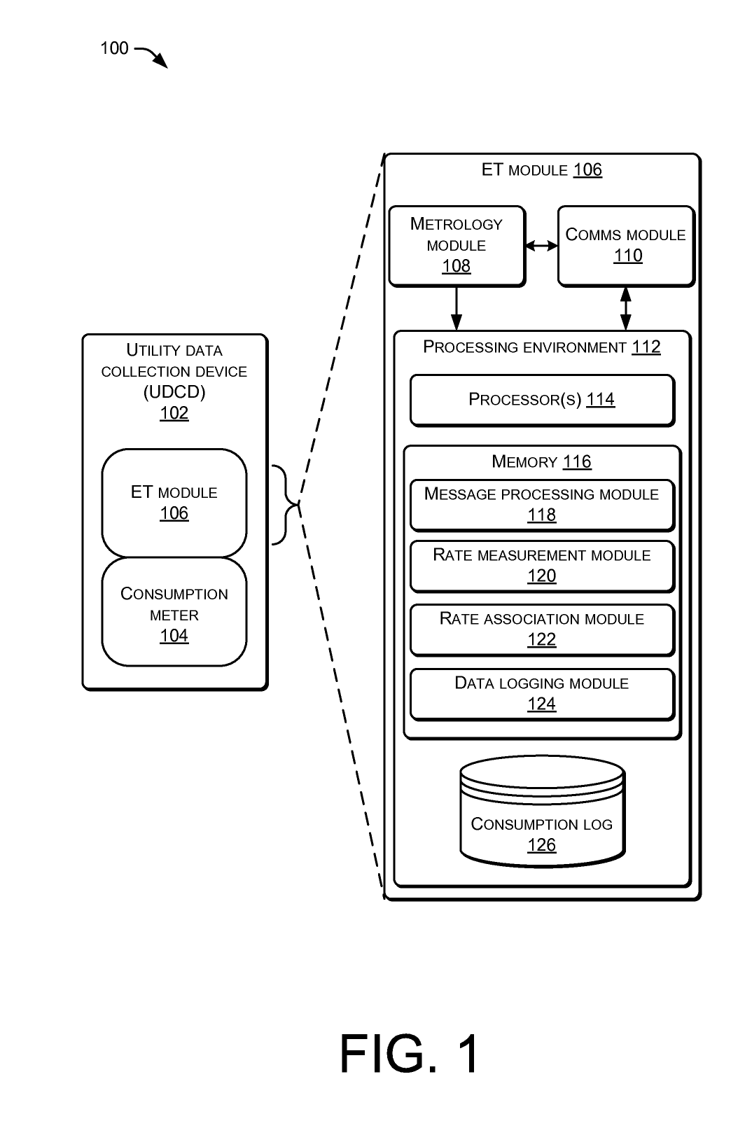

FIG. 1 is a schematic diagram of example architecture 100 of a utility data collection device for associating gas consumption and/or gas flow rates with gas consuming loads and/or gas appliances. As shown in example architecture 100, utility data collection device (UDCD) 102 (e.g., a smart utility gas meter) includes a consumption meter 104. As an example, consumption meter 104 may provide a signal or other data indicating measurement of a specific quantity of gas. The signal may also indicate a specific meter type or other information. Consumption meter 104 may be a mechanical rotary meter to include a residential or commercial diaphragm meter, an electro-mechanical meter, or any other type of meter that measures flow quantity (e.g., consumption quantity) over time, and provides corresponding consumption data.

Encoder-transceiver (ET) module 106 may be configured to process consumption data measured by consumption meter 104 and to measure and/or determine flow rates (e.g., gas flow rates). As an example, ET module 106 may be an encoder-receiver-transmitter (ERT®). ET module 106 may connect to, or integrate with, consumption meter 104 via a direct mount, a remote mount, an integrated construction, etc. ET module 106 and consumption meter 104 are shown in FIG. 1 as separate parts of utility data collection device 102 for simplicity of discussion, but could alternatively be combined or remotely connected.

As shown in FIG. 1, ET module 106 contains metrology module 108 for receiving and processing consumption data from consumption meter 104. Metrology module 108 may be configured to convert the consumption data provided by consumption meter 104 to specific units (e.g. cubic feet) and format the consumption data for processing, transmission and/or storage. Metrology module 108 may include memory, one or more processors and one or more modules for processing the consumption data from consumption meter 104.

ET module 106 may also include communications (i.e., comms) module 110. Comms module 110 allows UDCD 102 to communicate with external sources, such as a utility company central office, a mobile wireless meter reading device, a consumer, a user, or the like. Comms module 110 may be configured to format data, such as into frames or data packets associated with one or more communications protocols, and facilitate one-way or two-way communications with external entities. As an example, comms module 110 may include a radio frequency (RF) transceiver and antenna (not shown) to facilitate wireless communications, a power line communications (PLC) transceiver (not shown) for communication via a power line, a direct communication interface, etc. Metrology module 108 and comms module 110 may be communicatively coupled to each other and/or communicatively coupled to processing environment 112.

In the example of FIG. 1, the processing environment 112 is integrated into ET module 106. Processing environment 112 may include one or more processors 114 and memory 116. Memory 116 may comprise computer-readable storage media that includes, but is not limited to, RAM, ROM, EEPROM, flash memory, cache memory, or other hardware storage devices or hardware based memory technology. Processing environment 112 may include, or be part of, an application-specific integrated circuit (ASIC) or other suitable hardware logic. Memory 116 may store a variety of modules, such as message processing module 118, rate measurement module 120, rate association module 122 and data logging module 124. Separate from, or integrated with memory 116, is consumption log 126 for storing data associated with processing environment 112.

Message processing module 118 processes messages between UDCD 102 and a utility company, consumer, user, or the like. Message processing module 118 may processes various configuration commands to configure, for example, ET module 106. Message processing module 118 may be configured to respond to messages or commands to convey information to users. As an example, message processing module 118 may process external messages or commands received by comms module 110, and format data or response messages for transmission using comms module.

Rate measurement module 120 may be configured to process consumption information, such as data received from metrology module 108, to determine various consumption rates (e.g., instantaneous gas flow rates). As an example, rate measurement module 120 is configured to associate a time interval between known amounts of consumption at consumption meter 104, such that consumption rates may be measured over time intervals. Rate measurement module 120 may be configured to process consumption amounts provided by consumption meter 104 via metrology module 108 to determine gas flow rates at consumption meter 104. Rate measurement module 120 may be configured to pass measured consumption rates to rate association module 122.

Rate association module 122 may be configured to categorize measured consumption rates (e.g., gas flow rates) determined or measured by rate measurement module 120. As an example, rate association module 122 may accumulate measured gas flow rates in bins having ranges of gas flow rates that bracket the bins. For example, rate association module 122 may categorize gas flow rates into bins having different ranges, such as 60-80 BTUs, and 80-100 BTUs, etc. As such, rate association module 122 categorizes consumption rates received from rate measurement module 120 into one or more bins, each bin bracketed by a range of consumption rates.

Rate association module 122 may be configured to accumulate gas consumption data at various consumption rates in bins and sum consumption data within each of the various consumption rate bins over a measurement period. For example, the rate association module 122 may sum a total amount of gas used in a range of 80-90 cubic feet per hour (or in a range of 100-110 cubic feet per hour, etc.) over a billing or measurement period. Rate association module 122 may be configured to determine consumption rate trends and configure a number of bins, locations of bins and/or ranges of consumption rates that bracket the bins (e.g., bin distribution). Rate association module 122 may be configured to relate quantities of accumulated consumption data at various consumption rates to associate gas flow rates with gas consuming loads. As an example, rate association module 122 may detect accumulation of consumption data in multiple different bins, and associate the detected accumulation with gas consuming loads based on determining relative amounts of accumulated consumption data.

As an example, rate association module 122 may be configured to detect accumulation of consumption data at a boundary of two adjacent bins, and adjust bins such that the accumulated consumption data is accumulated in a single bin of the two adjacent bins. As another example, rate association module 122 may assign multiple bins of a plurality of bins to accumulate consumption by a consumption load in the assigned multiple bins.

As an example, if a residence has a water heater with a pilot light, a furnace with an electronic ignition, and a gas cooking stove, rate association module 122 may be configured to learn various consumption distribution rates for these gas consuming appliances such that a number of bins, bin sizes (i.e., width or range of consumption rates that bracket the bin) and/or bin locations are configured and adjusted to best accumulate consumption data for each gas consuming appliance. In an embodiment, rate association module 122 evaluates consumption data to optimize bin distribution.

Rate association module 122 may also be configured to optimize (e.g., a size and/or a location of) one or more bins that accumulate gas consumption associated with simultaneous operation of multiple gas appliances. As an example, a water heater may cycle on while a furnace is off, and a furnace may cycle on while the water heater is off. However, at times, both the water heater and furnace may operate simultaneously. In this case, rate association module 122 optimizes a bin location and range of gas flow rates that bracket the bin to accumulate gas flow rates indicating simultaneous operation of both the furnace and water heater while operating simultaneously. In an embodiment, rate association module 122 evaluates consumption data to resolve the contribution of the furnace and the water heater associated with the bin having accumulated gas flow rates indicating simultaneous operation of both the furnace and water heater. This allows for generation of a chart that resolves a total consumption and/or a total cost associated with the simultaneous operation of two or more individual gas consuming loads into constituent individual gas consuming loads.

As another example, if a consumer were to add an additional gas consuming load (e.g., gas appliance), rate association module 122 may re-allocate the distribution of bins to optimize an accumulation of consumption data of the prior and the additional gas consuming appliance(s). As another example, if a consumer were to replace a gas consuming appliance with a new, more energy efficient model that operates in a lower range of gas flow rates, rate association module 122 may re-allocate bin distribution to optimize an accumulation of gas consumption data of the new gas consuming appliance in an associated bin. As another example, if a consumer removes a gas appliance, the rate association module 122 may re-allocate bin distribution to optimize an accumulation of gas consumption data of the existing remaining gas appliances.

As another example, a consumer may have a gas appliance that is designed to operate at a fairly constant gas flow rate, but for some reason, such as a defect, the appliance starts operating at a different gas flow rate. Rate association module 122 is configured to re-allocate bin distribution to track the different gas flow rate of the potentially defective gas appliance. Upon receiving a chart showing this different gas flow rate, a consumer could determine that the gas appliance may have become defective and take appropriate action. Rate association module 122 may be configured to flag that the change has occurred.

Data logging module 124 is configured to store consumption data in consumption log 126. As an example, as consumption at measured gas flow rates are accumulated in bins, data logging module 124 stores the accumulated consumption data in consumption log 126. Data logging module 124 may be configured to format the consumption data, such that the accumulated consumption data associated with bins can be provided in chart form to a utility company, consumer, user, or the like. As an example, data logging module 124 formats the consumption data to facilitate generating a chart showing a total consumption and/or a total cost over a measurement period associated with individual gas consuming appliances. Therefore, a utility company, consumer, user, or the like may access information from consumption log 126 to determine total consumption associated with individual gas appliances.

ET module 106 may include computer-readable media. Computer-readable media may include two types of computer-readable media, namely computer-readable storage media and communications media.

Computer-readable storage media (e.g., memory 116, consumption log 126) includes volatile and non-volatile, removable and non-removable media implemented in any method or technology for storage of information such as computer readable instructions, data structures, program modules, or other data. Computer-readable storage media, such as consumption log 124, includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer-readable storage media does not include communication media.

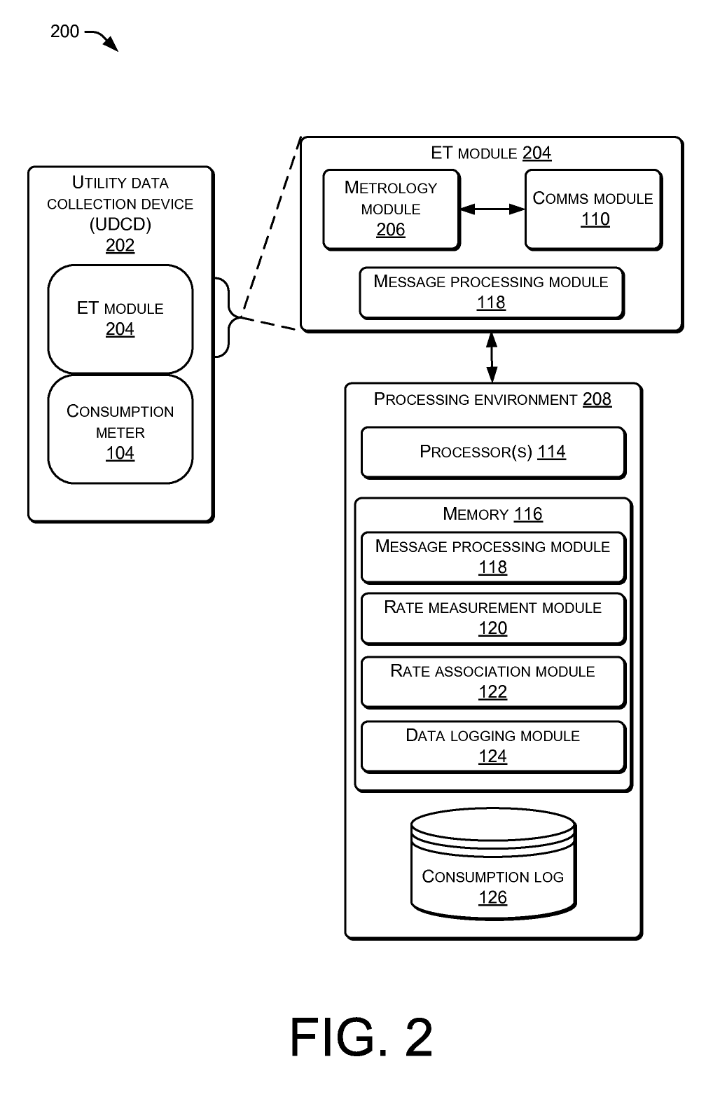

FIG. 2 is a schematic diagram of example architecture 200 of using a utility data collection device (e.g., smart gas meter) to associate gas flow rates with gas consuming loads in a distributed processing environment. As shown in example architecture 200, utility data collection device (UDCD) 202 (e.g., a smart utility meter) includes consumption meter 104, as described with respect to FIG. 1, and ET module 204.

ET module 204 includes metrology module 206, comms module 110 and message processing module 118, as described with respect to FIG. 1. Using message processing module 118, ET module 204 may respond to commands to provide consumption data obtained, for example, from consumption meter 104. Metrology module 206 may be configured to convert the consumption data provided by consumption meter 104 to specific units (e.g. cubic feet) and format the consumption data for processing, transmission and/or storage. Metrology module 206 may include memory, one or more processors and one or more modules (not shown) for formatting the consumption data from consumption meter 104. Metrology module 206 may be configured to provide consumption data to processing environment 208. As an example, metrology module 206 may provide consumption data to processing environment 208 using comms module 110 in response to a message request, or at various time durations.

In example architecture 200, processing environment 208 is shown as separate from ET module 204. Processing environment 208 may include a distributed processing environment in direct or indirect communication with UDCD 202, such as via comms module 110. As an example, processing environment 208 may be located at a utility company central office, or distributed among multiple offices or other locations. Processing environment 208 is shown in FIG. 2 to have the components processor(s) 114, memory 116, message processing module 118, rate measurement module 120, rate association module 122, data logging module 124 and consumption log 126, as described with respect to FIG. 1. Various components of processing environment 208 may be located in ET module 204. As an example, metrology module 206 and/or ET module 204 may contain some or all of the functionality associated with rate measurement module 120, as well as data logging module 124 and consumption log 126.

Thus, processing environment 208 may be configured to provide functionality comparable to the functionality provided by processing environment 112, described herein with regard to FIG. 1.

### Example Bin Allocation of Consumption Rates

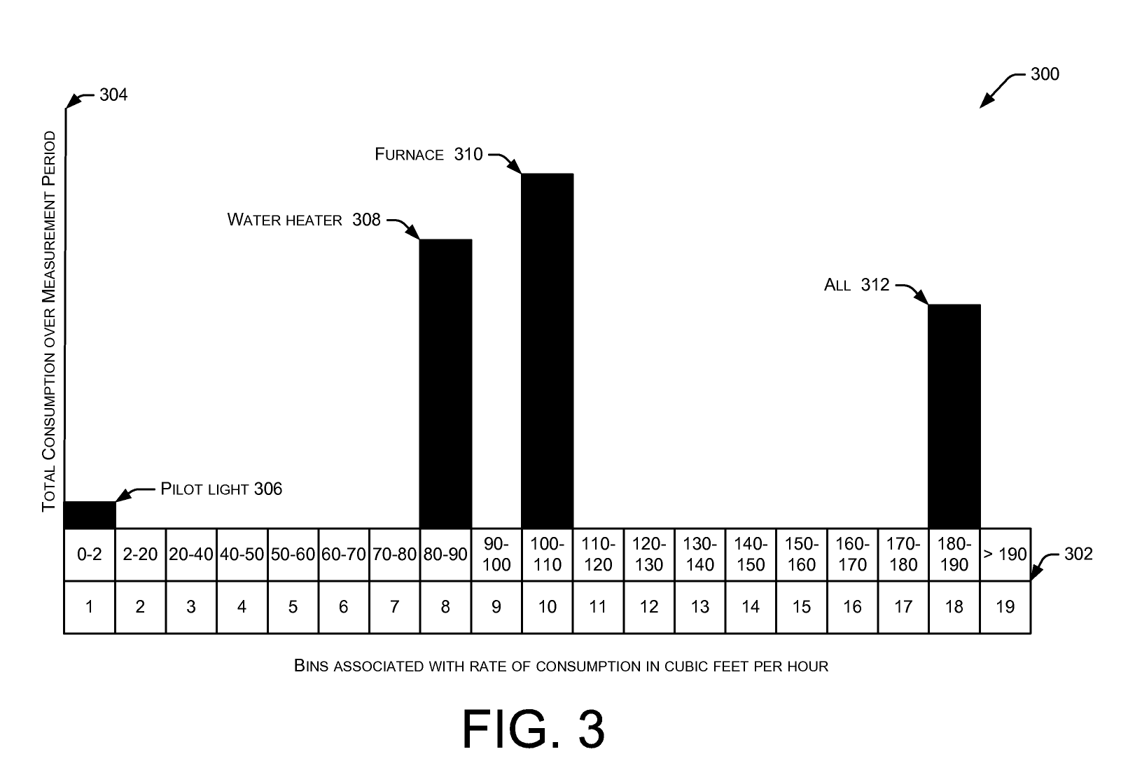

FIG. 3 is a diagram showing an example chart 300 of a distribution of bins and bin allocations at various consumption rate ranges. The horizontal x-axis 302 illustrates example bins 1-19 associated with various ranges of consumption rates. The vertical y-axis 304 measures accumulated consumption data over a measurement period, such as a day, a month or the like. As illustrated in FIG. 3, bin 1 is bracketed on x-axis 302 by a range of consumption rates of 0-2 cubic feet per hour. In the context of the example of FIG. 1, rate measurement module 120 detects a consumption rate of gas in the range of approximately 0.25 cubic feet per hour, where rate association module 122 allocates that consumption rate to bin 1 that brackets 0.25 cubic feet per hour with a range of consumption rates of 0-2 cubic feet per hour. As an example, bin 1 may be associated by a consumer, utility company or third party entity with a pilot light 306. Thus, rate association module 122 accumulates consumption data that falls in the range of 0-2 cubic feet per hour. This data may be summed to measure a total accumulated consumption over a measurement period, as illustrated by the height of pilot light 306 as measured on y-axis 304. Additionally, rate association module 122 may store data associated with an amount of gas consumed in the bin 1 range of 0-2 cubic feet per hour over a measurement period within the consumption log 126.

As illustrated in example chart 300, bin 8 is associated with a range of consumption rates of 80-90 cubic feet per hour of gas. In a similar aspect to bin 1, rate measurement module 120 detects a consumption rate in the range of 80-90 cubic feet per hour, and rate association module 122 accumulates the associated consumption rate data in bin 8. The consumption associated with bin 8 may be attributable to gas water heater 308. As an example, water heater 308 has pilot light 306. Therefore, since water heater 308 consumes gas at a substantially constant rate when it is cycled on, rate association module 122 accumulates the amount of gas consumed over time in bin 8.

Bin 10 is illustrated in FIG. 3 as associated with a range of consumption rates of 100-110 cubic feet per hour. In the example of FIG. 1, rate association module 122 accumulates the amount of gas consumed within a range of consumption rates of 100-110 cubic feet per hour, which may be displayed in bin 10. The accumulated amount of gas consumed in bins is measured along y-axis 304. As an example, gas consumption occurring within a consumption rate associated with bin 10 may be associated with gas furnace 310.

Bin 18 is illustrated in FIG. 3 as associated with a range of consumption rates of 180-190 cubic feet per hour. In the example of FIG. 1, rate association module 122 accumulates the amount of gas consumed within a range of consumption rates of 180-190 cubic feet per hour, which may be displayed in bin 18. The total amount of gas consumed as accumulated in bin 18 is measured along y-axis 304. As an example, gas consumption occurring within a consumption rate associated with bin 18 is associated with pilot light 306, water heater 308 and gas furnace 310 running simultaneously as all consuming appliances 312.

Rate association module 122 may be configured to resolve all consuming appliances 312 into constituent individual gas-consuming loads. As an example, based on a relative analysis of total consumption on y-axis 304 of pilot light 306, water heater 308 and furnace 310, rate association module 122 may be configured to resolve all consuming appliances 312 into constituent components of pilot light 306, water heater 308 and furnace 310. Other bins (e.g., 2-7, 9, 11-17 and 19) are associated with ranges of corresponding consumption rates as shown on x-axis 302 where no appreciable consumption data has been accumulated.

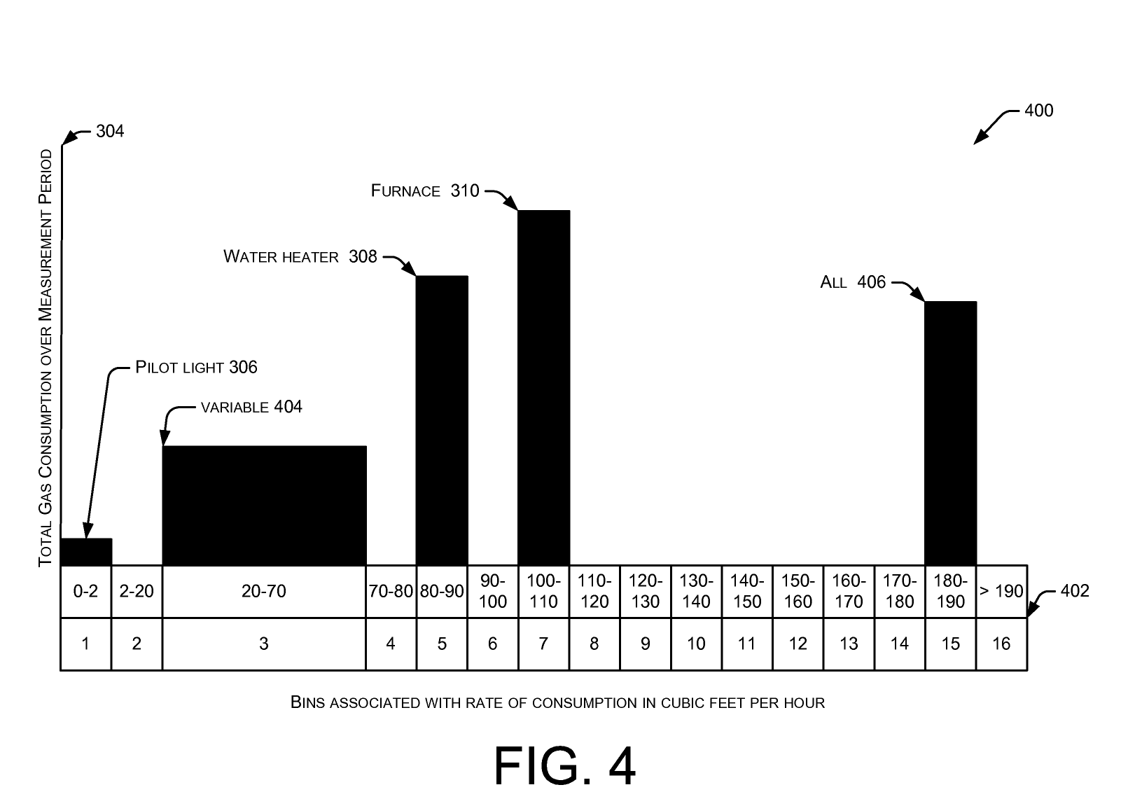

FIG. 4 is a diagram showing an example chart 400 of a distribution of bins according to various consumption rate ranges. Vertical axis 304, as shown in FIG. 3, measures total consumption associated with each bin. Horizontal x-axis 402 illustrates bins 1-16 associated with various ranges of consumption rates. In a manner that differs from example chart 300 of FIG. 3, FIG. 4 illustrates a different bin allocation or distribution along x-axis 402. In one example difference, bin 3 is associated with a consumption rate of 20-70 cubic feet per hour.

Rate measurement module 120 may detect consumption of gas at variable consumption rates in the range of 20-70 cubic feet per hour associated with variable gas consuming appliance 404, such as a gas cooking stove. The rate association module 122 may accumulate these variable consumption rates over bins 3-6 of FIG. 3, and data logging module 124 stores these variable consumption rates in consumption log 126. A utility, consumer, third party entity, or the like, may then analyze this data and recognize that it results from an appliance having variable gas rate consumption. Having recognized the nature of the consumption, the bins may be reorganized or adjusted as shown in FIG. 4.

As an example, a utility, consumer, third party entity, or the like, may send a command to ET module 106 or 204 to allocate bins as shown in FIG. 4. As another example, rate association module 122 may be configured to analyze data in consumption log 126 to learn that these variable consumption rates are persistent. As such, rate association module 122 reallocate bins on x-axis 402 to create a new bin 3, as shown in FIG. 4, associated with consumption rates of variable gas consuming appliance 404. Additionally, rate association module 122 may be configured to vary other bins on x-axis 402. As an example, rate association module 122 varies other bins on x-axis 402 based on an analysis of consumption data or observed consumption rates from rate measurement module 120. Rate association module 122 may widen or narrow a width of consumption rate ranges in bins to better capture consumption at consumption rates of individual appliances with corresponding bins. In one example, a comparison of FIGS. 3 and 4 shows a consolidation of various bins. As another example, based on evaluated or observed consumption rates, rate association module 122 may merge unused bins 9-13 on x-axis 402 into a single bin. As required, rate association module 122 may allocate any number of bins and any range of consumption rates (e.g., widths) of bins. If a consumer acquires a new gas consuming appliance that consumes gas according to a range of bin 11 (i.e., 140-150 cubic feet per hour), rate association module 122 accumulates consumption data associated with bin 11, and may merge unused bins 8-10 and bins 12-14 into individual respective bins.

FIG. 4 shows that bin 15 is associated with a consumption range of 180-190 cubic feet per hour. In the example of FIG. 1, the rate association module 122 measures the amount of gas consumed within a range of 180-190 cubic feet per hour over time in bin 15. The current total amount of gas consumed in bin 15 is measured along y-axis 304. FIG. 4 shows that gas consumption within a consumption range associated with bin 15 results from simultaneous operation 406 of pilot light 306, variable gas consuming appliance 404, water heater 308 and gas furnace 310. Other bins (e.g., 2, 4, 6, 8-14 and 16) are associated with ranges of corresponding consumption rates as shown on x-axis 402. FIG. 4 shows only one bin, bin 15, used to accumulate all simultaneous consumption. However, depending on the number of individual gas consuming loads, as well as their consumption rates, rate association module 122 may allocate multiple bins representing simultaneous consumption of other combinations of various gas consuming loads. As another example, due to the variability of variable gas consuming load 404, rate association module 122 may determine to not include variable gas consuming load 404 in all consuming appliances 406 running simultaneously.

Based on the loads rate association module 122 determines to include in all consuming appliances 406 running simultaneously, rate association module 122 may be configured to resolve which amount of consumption along axis 304 in all 406 is attributable to each consuming load. As an example, rate association module 122 may be configured to indicate what percentage of all consuming loads 406 running simultaneously is attributable to each of the pilot light 306, the water heater 308 and the furnace 310. Thus, rate association module 122 may be configured to resolve all consuming loads 406 into constituent individual gas consuming loads, to indicate portions attributed to loads 306, 308 and 310.

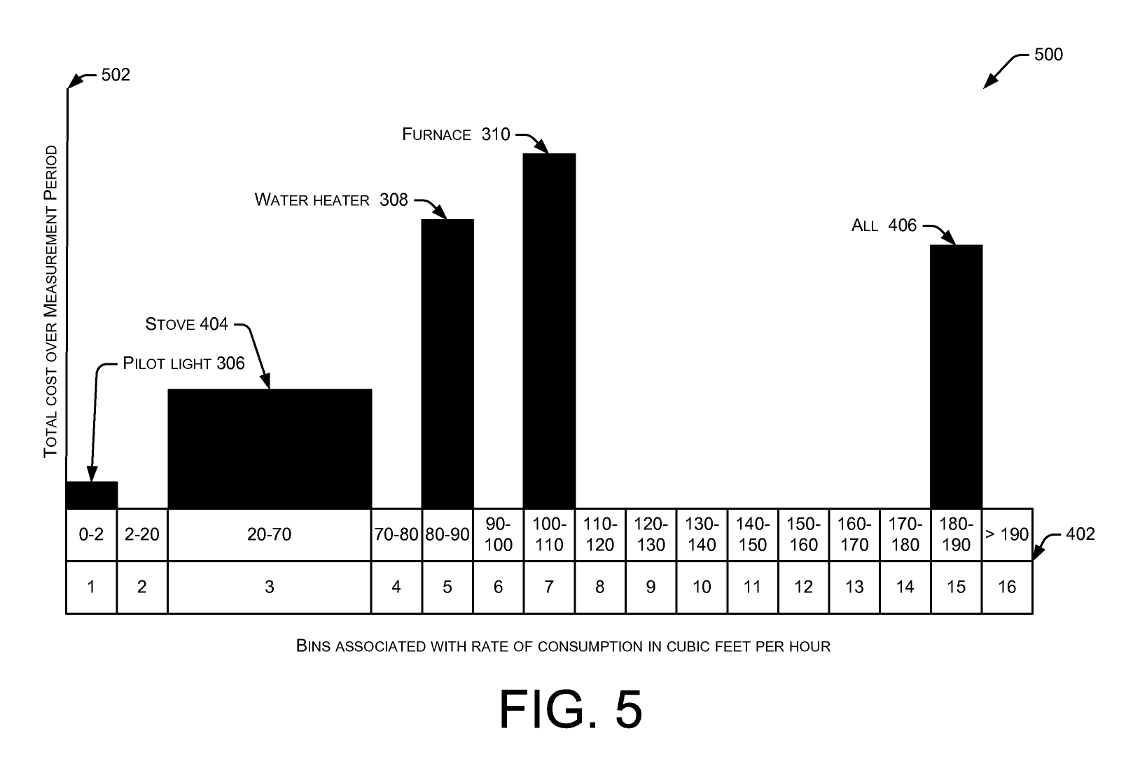

FIG. 5 is a diagram showing an example chart 500 of total accumulated costs 502 associated with various gas consuming appliances. Chart 500 represents a usage profile collected by the utility and made available to the customer through a website, a printed bill or invoice or an in-home display. An appliance may be associated with each step in flow rate, such as stove 404, pilot light 306, water heater 308, furnace 310, and simultaneous usage 406 by a homeowner, utility company, user, etc.

As an example, a 100,000 BTU furnace uses gas at a rate of 100 cubic feet per hour. A 65,000 BTU stove uses gas at a variable rate of 25-65 cubic feet per hour. An 80,000 BTU water heater uses gas at 80 cubic feet per hour. A pilot light uses 0.25 cubic feet per hour. FIG. 5 shows an example of how consumption in cubic feet as well as cost can be displayed for a home with a water heater with a pilot light, a gas stove and a furnace with electronic ignition.

Consumption log 126 may store additional information for use by a utility, consumer, third-party entity, or the like. As an example, consumption log 126 may contain data that associates time-of-day with distinct consumption rates 306, 404, 308, 310 and 406 such that data may be presented to a user on example chart 500 indicating various times of day that various gas consuming appliances consumed gas.

FIGS. 3-5 show examples of use of a single bin to show an amount of gas consumed at different rates. In an alternative, the rate association module 122 may allocate two or more bins to accumulate consumption for one or more of pilot light 306, stove 404, water heater 308, furnace 310 and all simultaneous consumption 406. As an example, in the alternative, bins 1-19 shown in FIG. 3 may each include multiple bins, such as 5 or more sub-bins. Rate association module 122 may be configured to select a number and location of sub-bins to adjust a number, location and width of bins associated with axis 302 in FIG. 3.

### Example Methods of Determining Consumption Rates

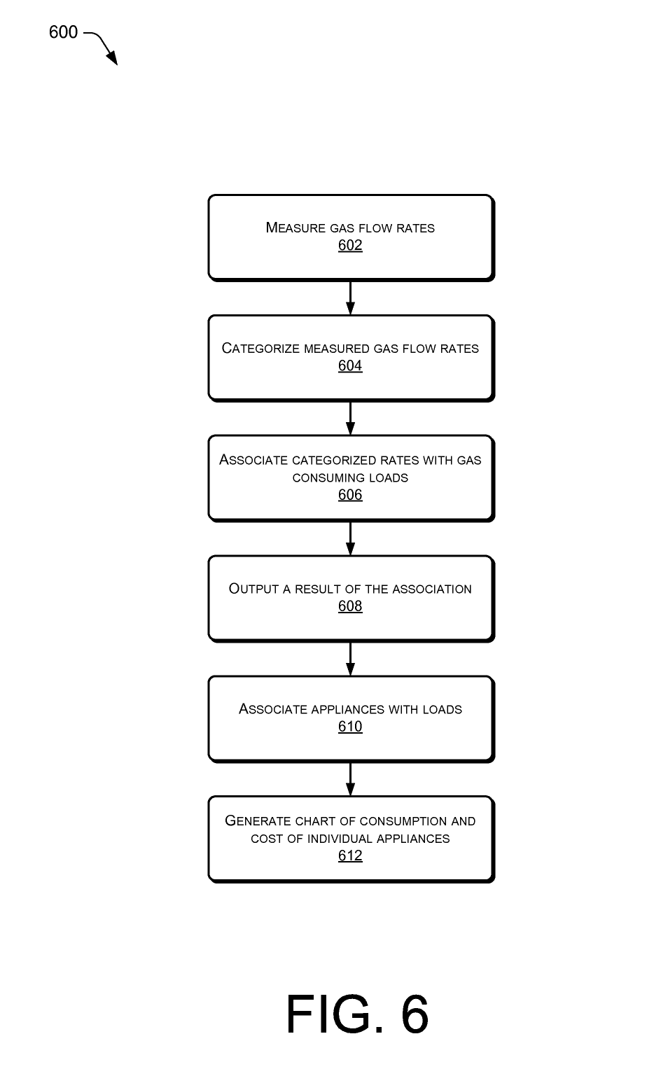

FIG. 6 illustrates an example method 600 of determining gas consuming loads associated with various consumption rates. Method 600 is described with reference to the example architecture 100 of FIG. 1 for convenience. However, method 600 is not limited to use with the example architecture 100 of FIG. 1 and may be implemented using other architectures and devices, such as architecture 200 shown in FIG. 2.

Method 600 begins at block 602, with measuring gas flow rates. As an example, rate measurement module 120 measures gas flow rates at consumption meter 104.

At block 604, the measured gas flow rates are categorized according to one or more levels or gas flow rate ranges. In one example, the rate association module 122 of FIG. 1 categorizes gas consumption at measured gas flow rates into corresponding bins. In the example, the rate measurement module 120 may measure a rate of 85 cubic feet/hour and rate association module 122 may categorize the measured gas flow rate with bin 5 in FIG. 5, which is bracketed by gas flow rates of 80 and 90 cubic feet/hour, such that bin 5 has a width of gas flow ranges of 10 cubic feet/hour. Rate association module 122 thus accumulates consumption of gas (e.g., records data) around 85 cubic feet/hour in bin 5 in FIG. 5. Thus, rate association module 122 accumulates consumption data at the measured gas flow rates in bins having ranges of gas flow rates that bracket the bins, such that the categorizing the measured gas flow rates comprises associating the measured gas flow rates with ranges of gas flow rates. As an example, rate association module 122 may categorize gas flow rates of individual gas consuming appliances and gas flow rates of simultaneous operation of two or more of the individual gas consuming appliances into corresponding ranges of gas flow rates.

At block 606, categorized gas flow rates are associated with gas consuming loads. As an example, based on detecting a quantity of gas consumed by a gas consuming load at a rate of about 85 cubic feet/hour, rate association module 122 may determine that bin 5 in FIG. 5, having a range of gas flow rates of 80-90 cubic feet/hour, is associated with the gas consuming load. As another example, based on a quantity of gas consumed around 105 cubic feet/hour, rate association module 122 may determine that bin 7 in FIG. 5 is associated with a gas consuming load. Rate association module 122 may then determine that a quantity of gas consumed around 185 cubic feet/hour is associated with bin 15 in FIG. 5 and is attributable to simultaneous operation of consuming loads 308 and 310 in FIG. 5. Therefore, rate association module 122 recognizes gas flow rates of individual gas consuming loads and gas flow rates indicating simultaneous operation of at least two of the individual gas consuming loads.

At block 608, a result of the associating the categorized gas flow rates with gas consuming loads may be output. As an example, the result output includes accumulated gas flow rate data associated with the gas consuming loads. As another example, the result includes accumulated consumption at gas flow rates of individual gas consuming loads and accumulated consumption at gas flow rates indicating simultaneous operation of two or more of the individual gas consuming loads, accumulated in a plurality of bins or ranges of gas flow rates. As an example, the result may include usage data such that the usage data of at least two of the gas consuming appliances includes data obtained while at least two gas consuming appliances were simultaneously operational.

The result of data associated with consumption accumulated in bins over a measurement period, such as illustrated in FIGS. 3-5, may be output. In the context of the example of FIG. 1, message processing module 118 may receive a command from a utility company, consumer, or the like, to provide accumulated consumption data in bins. In response to the command, data logging module 124 may format the data, such that the data is provided for transmission via comms module 110. The ET module 106 may be configured to periodically or a-periodically provide the result of accumulated consumption data in the bins.

At block 610, gas consuming appliances are associated with at least a subset of the gas consuming loads. As such, the categorized gas flow rates may be associated with gas consuming loads that comprise associating the categorized gas flow rates with gas consuming appliances. A user interface may be presented to a consumer, allowing the consumer to associate gas consuming appliances with one or more of the gas consuming loads. As such, an association may be received, through operation of the user interface, of one or more gas consuming appliances with at least one gas consuming load. Alternatively, gas consuming appliances may be associated with one or more of the gas consuming loads based at least in part on known consumption rates of the gas consuming appliances.

At block 612, the result output may be used to generate a chart based at least in part on the result showing total consumption and/or total cost over a measurement period associated with individual gas consuming appliances. As an example, data logging module 124 may be configured to generate the chart associated with individual gas consuming appliances. The chart may resolve total consumption and/or the total cost associated with the simultaneous operation of two or more of the individual gas consuming loads into constituent individual gas consuming loads. As another example, the result output by data logging module 124 may be used by an external entity to generate the chart showing total consumption and/or total cost over a measurement period associated with individual gas consuming appliances that resolves simultaneous operation of the two or more of the individual gas consuming appliances into constituent individual gas consuming appliances. In the case where gas consuming appliances have been associated with gas consuming loads, the charts may be annotated to show consumption of individual gas consuming appliances.

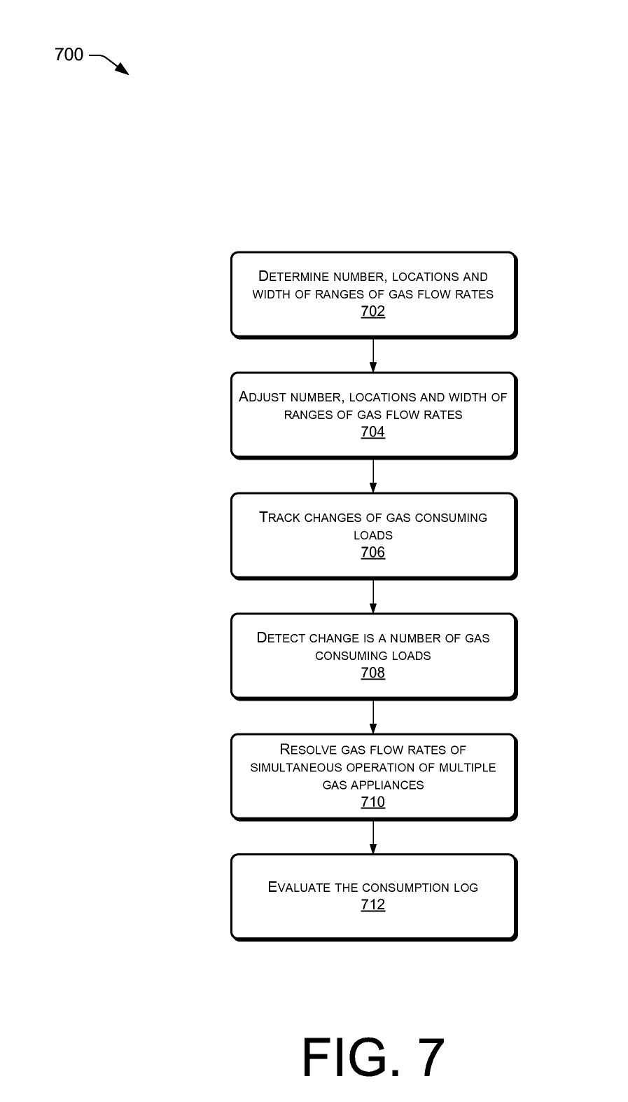

FIG. 7 illustrates an example method 700 to determine gas consuming loads associated with various consumption rates. Method 700 is described with reference to the example architecture 100 of FIG. 1 for convenience. However, method 700 is not limited to use with the example architecture 100 of FIG. 1 and may be implemented using other architectures and devices, such as architecture 200 shown in FIG. 2.

As an example, bins (e.g., ranges of gas flow rates) used to accumulate consumption data at various consumption rates may be predefined with a default bin distribution, such as illustrated in FIG. 3. During operation, upon determining gas consumption at various gas consumption rates, rate association module 122 may adjust a range of gas consumption associated with one or more bins to better capture consumption at various consumption rates.

At block 702, a number of ranges of gas flow rates (e.g., number of bins) are determined, locations of ranges of gas flow rates (e.g., bin locations) are determined and a width (e.g., bin width) of each of the ranges or gas flow rates are determined. At block 704, bins may be adjusted by rate association module 122 based on the determined number of bins, locations of bins and/or ranges of gas flow rates that bracket each of the bins. In the example of FIG. 3, bins 1-19 may not be aligned or best adjusted to accumulate consumption of pilot light 306, water heater 308, furnace 310 and simultaneous operation of appliances 312. Therefore, rate association module 122 may be configured to change the number of bins, change the location of the bins and change the range of gas flow rates that bracket the bins to best accumulate consumption of pilot light 306, water heater 308, furnace 310 and simultaneous operation of appliances 312.

At block 706, changes of categorized gas flow rates associated with the gas consuming loads are tracked and the categorizing of the measured gas flow rates may be adjusted based on the tracked changes. In the context of the example of FIG. 3, assume that due to a defect or other phenomenon, the rate of gas consumption of water heater 308 changes to be between bins 7 and 8 or bins 8 and 9. In this example, rate association module 122 is configured to adjust bins to track the changed consumption rate of water heater 308. As an example, rate association module 122 may change a location of bin 8 by shifting it in the direction of the changed consumption rate of water heater 308. As another example, rate association module 122 may remove a bin to widen bin 8 to best accumulate consumption at the changed consumption rate of water heater 308. Rate association module 122 may reduce a range of other bins to account for a shift or widening of the ranges of bin 8. As an example, data logging module 124 may be configured to flag that a consumption rate has changed to alert a consumer.

At block 708, a change in a number of gas consuming loads is detected. As an example, the change in the number of gas consuming loads may be reflected in an output and/or a chart as a changed number of gas consuming appliances associated with gas consuming loads. As an example, rate association module 122 may adjust bins to accommodate a removal or addition of one or more gas consuming loads. Referring again to FIG. 4, assume that variable gas consuming load 404 was newly added. As shown in example FIG. 4, rate association module 122 has reduced the number of bins (relative to FIG. 3) and has changed the range of gas flow rates that bracket bin 3 (e.g., changed the width of bin 3) to best accommodate accumulation of consumption data of variable gas consuming load 404. Therefore, rate association module 122 may be configured to detect a change in a number of the gas consuming loads, and in response to detecting the change in the number of the gas consuming loads, determine at least one of a new number of the bins, new locations of the bins or new widths of ranges of gas flow rates that bracket the bins.

At block 710, the gas flow rates of simultaneous operation of two or more of the individual gas consuming appliances are resolved to indicate consumption by each individual gas consuming appliance. As an example, referring back to FIG. 3, data logging module 124 may log accumulated consumption of pilot light 306, water heater 308, furnace 310 and simultaneous operation of appliances 312 in consumption log 126. Data logging module 124 may be configured to log the accumulated gas flow rates of the individual gas consuming loads and the accumulated gas flow rates indicating simultaneous operation of two or more of the individual gas consuming loads in consumption log 126. Rate association module 122 may evaluate consumption log 126 to resolve the simultaneous operation of two or more of the individual gas consuming appliances to indicate consumption by each appliance and update at least one of a number, a location, or ranges of gas flow rates that bracket the bins of the plurality of bins. Thus, at block 712, rate association module 122 may be configured to evaluate consumption log 126 to perform aspects of the methods described in blocks 702-710 above.

### CONCLUSION

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
under control of one or more processors configured with executable instructions:
measuring gas flow rates;
categorizing the measured gas flow rates;
associating the categorized gas flow rates with gas consuming loads; and
outputting a result of the associating.

2. The method of claim 1, wherein the associating recognizes:
gas flow rates of individual gas consuming loads; and
gas flow rates indicating simultaneous operation of at least two of the individual gas consuming loads.

3. The method of claim 1, wherein the categorizing the measured gas flow rates comprises categorizing the measured gas flow rates into ranges of gas flow rates.

4. The method of claim 3, further comprising:
determining a number of the ranges of gas flow rates;
determining locations of the ranges of gas flow rates; and
determining a width of each of the ranges of gas flow rates.

5. The method of claim 4, further comprising:
detecting a change in a number of the gas consuming loads;
in response to the detecting the change in the number of the gas consuming loads, determining at least one of:
a new number of the ranges;
new locations of one or more of the ranges; or
new widths of one or more of the ranges of gas flow rates.

6. The method of claim 1, wherein the associating the categorized gas flow rates with gas consuming loads comprises:
presenting a consumer with a user interface; and
receiving an association, through operation of the user interface, of at least one gas consuming appliance with at least one gas consuming load.

7. The method of claim 1, wherein the associating the categorized gas flow rates with gas consuming loads comprises associating one or more gas consuming appliances with one or more of the gas consuming loads based at least in part on known consumption rates of the gas consuming appliances.

8. The method of claim 1, further comprising:
tracking changes over time of the categorized gas flow rates associated with the gas consuming loads; and
adjusting the categorizing of the measured gas flow rates based on the tracked changes.

9. The method of claim 1, wherein associating the categorized gas flow rates with gas consuming loads comprises associating the categorized gas flow rates with gas consuming appliances.

10. The method of claim 9, wherein outputting the result comprises outputting a chart showing at least one of a total consumption or total cost over a measurement period associated with individual gas consuming appliances.

11. A system comprising:
a consumption measuring meter configured to measure gas flow;
one or more processors in communication with the consumption measuring meter, the one or more processors configured to:
measure gas flow rates of the gas flow;
categorize the measured gas flow rates;
associate the categorized gas flow rates with gas consuming loads; and
output accumulated gas flow rate data associated with the gas consuming loads.

12. The system of claim 11, wherein the one or more processors are additionally configured to:
recognize gas flow rates of individual gas consuming loads; and
recognize gas flow rates indicating simultaneous operation of two or more of the individual gas consuming loads.

13. The system of claim 11, wherein associating the categorized gas flow rates with consuming loads comprises associating the categorized gas flow rates with one or more appliances.

14. The system of claim 13, wherein the one or more processors are configured to:
detect a change in a number of the individual gas consuming loads; and
change the output to reflect a changed number of appliances associated with gas consuming loads.

15. The system of claim 13, wherein the output shows:
a total consumption or total cost over a measurement period associated with the individual gas consuming loads; and
simultaneous operation of two or more of the individual gas consuming loads.

16. The system of claim 15, wherein the output resolves simultaneous operation of two or more gas consuming loads into constituent individual gas consuming loads.

17. One or more computer-readable storage media having instructions, that when executed by one or more processors, perform acts comprising:
measuring gas flow rates;
associating the measured gas flow rates with gas consuming appliances; and
outputting usage data of each of the gas consuming appliances.

18. The one or more computer-readable storage media of claim 17, wherein usage data of at least two of the gas consuming appliances includes data obtained while the at least two gas consuming appliances were simultaneously operational.

19. The one or more computer-readable storage media of claim 17, the acts further comprising:
measuring gas flow rates of individual gas consuming appliances and gas flow rates of simultaneous operation of two or more of the individual gas consuming appliances; and
resolving the gas flow rates of simultaneous operation of the two or more of the individual gas consuming appliances to indicate consumption by each.

20. The one or more computer-readable storage media of claim 17, the acts further comprising:
categorizing the measured gas flow rates within ranges of consumption;
wherein the associating is based in part on the categorizing.
